(19) United States
(12) Patent Application Publication
(10) Pub. No.: US 2026/0087665 A1
(43) Pub. Date: Mar. 26, 2026

(54) POSITIONING METHOD, APPARATUS, AND SYSTEM FOR A PHOTOVOLTAIC ROBOT

(71) Applicant: Huzhou Leapting Technology Co., LTD, Huzhou (CN)

(72) Inventors: Chunbo Xu, Huzhou, Zhejiang (CN); Shitao Wang, Huzhou, Zhejiang (CN); Ye Zhang, Huzhou, Zhejiang (CN)

(73) Assignee: Huzhou Leapting Technology Co., LTD, Huzhou (CN)

(21) Appl. No.: 19/288,199

(22) Filed: Aug. 1, 2025

(30) Foreign Application Priority Data
Sep. 24, 2024 (CN) 202411328439.7

(51) Int. Cl. G06T 7/73; B25J 9/16; G06T 7/13

(52) U.S. Cl. CPC G06T 7/73; B25J 9/1664; G06T 7/13; G06T 2207/10028

(57) ABSTRACT

A positioning method, apparatus and system for a photovoltaic robot is disclosed. The method comprises: obtaining three-dimensional point cloud data of the photovoltaic bracket, wherein the three-dimensional point cloud data is obtained through a sensing device; determining a target straight line based on the three-dimensional point cloud data, wherein the target straight line comprises a straight line where a target structure of the photovoltaic bracket is located, and the target straight line is located in the plane where the photovoltaic bracket is located; determining the position information based on a first rotation matrix between a first coordinate system of the sensing device and a second coordinate system of the photovoltaic robot, as well as the target straight line; wherein the position information indicates a relative position relationship between the photovoltaic robot and the target structure. Thus, the photovoltaic robot is positioned and its abnormal pose could be detected in time.

### FIELD OF THE DISCLOSURE

The present application relates to the field of photovoltaic technology, and in particular to a positioning method, apparatus, and system for a photovoltaic robot.

### BACKGROUND

Photovoltaic panels can convert solar energy into electrical energy. Photovoltaic panels are installed on photovoltaic brackets, which are used to fix and support photovoltaic panels so that the photovoltaic panels can maximize the absorption and conversion of solar energy. If photovoltaic panels are automatically installed by a photovoltaic robot, and the pose of the photovoltaic robot relative to the photovoltaic bracket is abnormal during the installation process, it may cause the installation position of the photovoltaic panels to deviate, thereby affecting the efficiency of the photovoltaic robot's automatic installation. Even worse, the photovoltaic panels may be damaged due to the collision with the photovoltaic robot.

Therefore, it is very important to accurately position the photovoltaic robot.

### SUMMARY OF THE INVENTION

In order to solve the above technical problems, the present application provides a positioning method, apparatus, and system for a photovoltaic robot to facilitate accurate positioning of the photovoltaic robot.

Specifically, the technical solutions of this application are as follows:

In a first aspect, a positioning method for a photovoltaic robot is provided, which is used for the photovoltaic robot to install a photovoltaic panel on a photovoltaic bracket. The positioning method is used to determine the position information of the photovoltaic robot during the installation of the photovoltaic panel. The positioning method comprises:
obtaining three-dimensional point cloud data of the photovoltaic bracket, wherein the three-dimensional point cloud data is obtained through a sensing device;
determining a target straight line based on the three-dimensional point cloud data, wherein the target straight line comprises a straight line where a target structure of the photovoltaic bracket is located, and the target straight line is located in the plane where the photovoltaic bracket is located;
determining the position information based on a first rotation matrix between a first coordinate system of the sensing device and a second coordinate system of the photovoltaic robot, as well as the target straight line; wherein the position information is used to indicate a relative position relationship between the photovoltaic robot and the target structure.

In this way, the relative position relationship between the photovoltaic robot and the photovoltaic bracket is determined based on the three-dimensional point cloud data of the photovoltaic bracket, and the photovoltaic robot can be accurately positioned during the process of installing photovoltaic panels by the photovoltaic robot, so as to detect abnormal pose of the photovoltaic robot in time. In addition, the above positioning method determines the target straight line based on the three-dimensional point cloud data, where the target straight line is a planar straight line. In this way, the three-dimensional point cloud data is converted into a two-dimensional planar straight line. By applying dimensionality reduction, the data processing workflow can be optimized to improve positioning efficiency.

In one implementation, said determining a target straight line based on the three-dimensional point cloud data, comprising: extracting edge point cloud data from the three-dimensional point cloud data; wherein the three-dimensional point cloud data comprises three-dimensional position coordinates of multiple spatial points, and the edge point cloud data comprises three-dimensional position coordinates of multiple edge points; the multiple edge points constitute point cloud of a geometric shape boundary of the photovoltaic bracket; performing two-dimensional processing on the edge point cloud data to get two-dimensional data of the multiple edge points; and determining the target straight line based on the two-dimensional data of the multiple edge points.

In this way, the point cloud of the geometric shape boundary of the photovoltaic bracket is extracted from the point cloud of the photovoltaic bracket by the edge detection method, thereby obtaining the edge point cloud data. Based on the edge point cloud data, the target straight line corresponding to the target structure is accurately identified.

In one implementation, said determining the target straight line based on the two-dimensional data of the multiple edge points comprises:
selecting a first edge point and a second edge point from the multiple edge points;
   determining a first planar straight line based on two-dimensional data of the first edge point and the second edge point; determining the first planar straight line as a first candidate straight line when a number of inner points of the first planar straight line is greater than or equal to a first preset number;
traversing the multiple edge points, when there are multiple first candidate straight lines, determining a candidate straight line with a largest number of inner points among the multiple first candidate straight lines as an initial target candidate straight line;
selecting a third edge point and a fourth edge point from an initial edge point set;
   determining a second planar straight line based on two-dimensional data of the third edge point and the fourth edge point; determining the second planar straight line as a current target candidate straight line when a number of inner points of the second planar straight line is greater than or equal to a second preset number; wherein the initial edge point set comprises the remaining edge points after removing the inner points of the initial target candidate straight line from the multiple edge points;
repeating the following iterative process until a number of the target candidate straight lines is greater than or equal to a third preset number:
selecting a fifth edge point and a sixth edge point from a current edge point set;
   determining a third planar straight line based on two-dimensional data of the fifth edge point and the sixth edge point; updating the current target candidate straight line based on the third planar straight line when the number of inner points of the third planar straight line is greater than or equal to a fourth preset number; wherein the current edge point set comprises the remaining edge points after removing the inner points of the current target candidate straight line from the initial edge point set;
determining the target candidate straight line with a largest number of inner points as the target straight line when the number of target candidate lines is greater than or equal to the third preset number.

In this way, the initial target candidate line is iterated in a loop to determine the final target straight line. The accuracy of the target straight line detection is improved through loop iteration.

In one implementation, multiple inner points of the target straight line are divided into multiple inner point sets, and the inner points that meet a first adjacent condition among the multiple inner points of the target straight line belong to the same inner point set. The above positioning method further comprises: determining multiple fourth planar straight lines by performing straight line fitting based on the multiple inner point sets; determining multiple first planar straight lines based on the straight line with the largest number of inner points among the multiple fourth planar straight lines, and re-determining multiple target straight lines; selecting a new target straight line from the re-determined multiple target straight lines. The new target straight line comprises the straight line with the longest length and/or the largest number of inner points among the re-determined multiple target straight lines.

In one implementation, the positioning method further comprises: determining a first distance between multiple edge points and the first planar straight line based on two-dimensional data of the multiple edge points; determining an edge point corresponding to the first distance from the multiple edge points as an inner point of the first planar straight line when the first distance is less than or equal to the first preset distance.

In one implementation, multiple spatial points constitute a first point cloud region; the multiple spatial points comprise a first point, the first point also belongs to a second point cloud region, the second point cloud region is less than or equal to the first point cloud region; and the spatial points in the second point cloud region meet a second adjacent condition; the second point cloud region further comprises a second point. Said extracting the edge point cloud data of a photovoltaic bracket from three-dimensional point cloud data comprises:
determining the curvature information of the first point based on the three-dimensional position coordinates of the second point cloud region; wherein the curvature information comprises a curvature value of the first point and/or an angle value between the normal of the first point and the normal of the second point; taking the first point as the edge point when the curvature information meets a preset curvature condition.

In one implementation, said determining the curvature information of the first point based on the three-dimensional position coordinates of the second point cloud region comprises: performing surface fitting with the first point and the second point as center points, respectively, based on the three-dimensional position coordinates of the second point cloud region, to obtain a first surface and a second surface; determining the curvature value of the first point and the angle value between the normal of the first point and the normal of the second point based on the feature information of the first surface and the second surface.

In one implementation, the positioning method further comprises: performing filtering on the three-dimensional point cloud data; wherein the filtering comprises one or more of pass-through filtering, voxel grid filtering, and outlier removal filtering.

In one implementation, the position information comprises a first angle between the photovoltaic robot and the target structure. Said determining the position information based on the first rotation matrix between the first coordinate system of the sensing device and the second coordinate system of the photovoltaic robot, as well as the target straight line comprises: determining a second angle between the target straight line and a first direction; determining a second rotation matrix between the first coordinate system and a third coordinate system based on the second angle; wherein the third coordinate system comprises a coordinate system of the target structure; determining a third rotation matrix between the second coordinate system and the third coordinate system based on the first rotation matrix and the second rotation matrix; and determining the first angle based on the third rotation matrix.

In a second aspect, a positioning apparatus for a photovoltaic robot is provided, comprising a processor for calling instructions stored in a memory, wherein when the instructions are called by the processor, the processor executes the positioning method implemented in the first aspect or any one of the first aspects.

In a third aspect, a positioning system for a photovoltaic robot is provided, comprising:
a sensing device, which is installed on the photovoltaic robot and is used to collect sensing data of the photovoltaic bracket, wherein the sensing data comprises three-dimensional point cloud data, or the sensing data is used to determine the three-dimensional point cloud data;
a positioning apparatus of the second aspect, which is coupled to the sensing device.

### BRIEF DESCRIPTION OF THE DRAWINGS

The following is a brief introduction to the drawings used in describing the embodiments of the present application:

FIG. 1 is a schematic diagram of a photovoltaic panel installation scenario provided in an embodiment of the present application;

FIG. 2 is a schematic structural diagram of a positioning system for a photovoltaic robot provided in an embodiment of the present application;

FIG. 3 is a flow chart of a positioning method for a photovoltaic robot provided in an embodiment of the present application;

FIG. 4 is a flow chart of determining a target straight line based on three-dimensional point cloud data of a photovoltaic bracket provided in an embodiment of the present application;

FIG. 5 is a schematic diagram of a target straight line determination process provided in an embodiment of the present application;

FIG. 6 is a schematic structural diagram of a positioning apparatus for a photovoltaic robot provided in an embodiment of the present application.

### DESCRIPTION OF THE ILLUSTRATED EMBODIMENTS

In order to more clearly illustrate the embodiments of the present application or the technical solutions in the prior art, the specific implementation methods of the present application will be described below with reference to the accompanying drawings. The accompanying drawings described below are only some embodiments of the present application. For ordinary technicians in this field, other accompanying drawings and other implementation methods can be obtained based on these drawings without creative work. Adjustments and improvements made without departing from the concept of the present application are all within the scope of protection of the present application.

In order to simplify the drawings, the drawings in the embodiments of the present application only schematically show the parts related to the present application, and they do not represent the actual structure of the product. In addition, in order to simplify the drawings and facilitate understanding, in some drawings, only parts with the same structure or function are schematically shown, and there may be more or fewer parts with the same structure or function in reality.

In this application, unless otherwise clearly specified and limited, ordinal numbers, such as “first”, “second”, etc., are only used to distinguish and describe associated objects, and cannot be understood as indicating or implying the relative importance or order between associated objects; in addition, they do not represent the number of associated objects. “Multiple” comprises two or more, and other quantifiers are similar. “/” is used to describe the relationship between associated objects, which indicates the “or” relationship between associated objects. “One or more” or “at least one” of multiple objects refers to any object or any combination of multiple objects, for example, “one or more of a1, a2, a3” or “at least one of a1, a2, a3” comprises: “alone a1”, “alone a2”, “alone a3”, “a1 and a2”, “a1 and a3”, “a2 and a3” or “a1, a2 and a3”.

The terms “installation” and “connection” should be understood in a broad sense. For example, “installation” can be direct installation or installation through other components; “connection” can be fixed connection, detachable connection, or integral connection; it can be mechanical connection or electrical connection; it can be direct connection or indirect connection through an intermediate medium, or it can be inner communication between two components. For ordinary technicians in this field, the specific meanings of the above terms in this application can be understood based on specific circumstances.

In a photovoltaic power generation scenario, photovoltaic panels (also known as photovoltaic modules) are fixed and supported by photovoltaic brackets. Photovoltaic brackets enable photovoltaic panels to face the sun at the best angle to maximize the absorption of the solar energy and convert the solar energy into electrical energy. Photovoltaic panels are installed by photovoltaic robots. Furthermore, the photovoltaic robot also comprises a mobile device to facilitate carrying photovoltaic panels to different locations for installation. Please refer to FIG. 1, which is a schematic diagram of a photovoltaic panel installation scenario provided in an embodiment of the present application. As shown in FIG. 1, it is assumed that the direction of the arrow in FIG. 1 is the direction of travel of the photovoltaic robot 110. The photovoltaic robot 110 walks along the direction of travel relative to the photovoltaic bracket 120, and installs the photovoltaic panel at the corresponding position of the photovoltaic bracket 120 during the movement, as shown by the shadow in FIG. 1.

The photovoltaic robot has an initial pose. The initial pose maintains a certain relative position relationship with the photovoltaic bracket, such as being vertical to the ground, parallel with the inclination angle of the photovoltaic bracket, and so on. If the photovoltaic robot maintains the initial pose or is within the error range of the initial pose during the installation process, the photovoltaic panel can be accurately installed in the appropriate position. However, during the movement of the photovoltaic robot, the ground may be uneven or the control error of the photovoltaic robot may occur, causing the pose of the photovoltaic robot to change, as shown in the dotted box in FIG. 1. The dotted box represents several possible situations in which the robot's pose changes. They are only examples and do not represent the actual pose change of the photovoltaic robot. This situation will cause the current pose of the photovoltaic robot to deviate from the initial pose, resulting in a deviation in the installation position of the photovoltaic panel, which will cause the photovoltaic panel to be unable to be accurately installed on the photovoltaic bracket. And as the photovoltaic robot continues to move forward, this deviation will continue to accumulate, and eventually manual adjustment will be required, increasing the cost of operation and maintenance.

It can be seen that the change of the pose of the photovoltaic robot may affect the installation of the photovoltaic panel. Considering the above problems, the embodiment of the present application proposes a positioning method, apparatus for a photovoltaic robot and other solutions, which can accurately position the photovoltaic robot, facilitate timely detection of abnormal pose of the photovoltaic robot, so that the pose of the photovoltaic robot can be controlled and adjusted in time, reduce the deviation in the installation process of the photovoltaic panel, and facilitate accurate installation of the photovoltaic panel in the appropriate position.

The following is a description with reference to the figures.

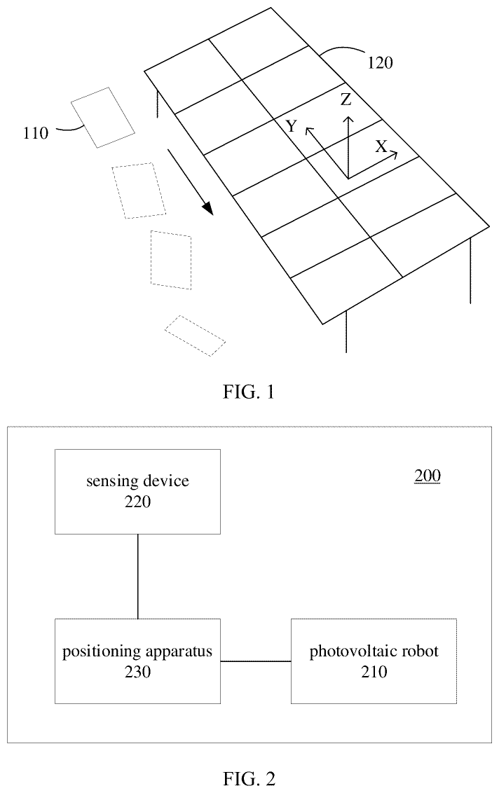

Please refer to FIG. 2, which is a schematic structural diagram of a positioning system for a photovoltaic robot provided in an embodiment of the present application. As shown in FIG. 2, the positioning system 200 comprises a photovoltaic robot 210, a sensing device 220, and a positioning apparatus 230. The sensing device 220 is used to collect the sensing data of the photovoltaic bracket. The sensing data comprises, for example, three-dimensional point cloud data; or the sensing data is used to determine the three-dimensional point cloud data, and the sensing data is, for example, a depth image. The sensing device 220 can be installed on the photovoltaic robot 210 to collect the sensing data of the photovoltaic bracket in real time during the installation of the photovoltaic panel. For example, the sensing device 220 can be installed on the robot's mechanical arm to obtain a better sensing field of view. In one implementation, the sensing device 220 can be installed at the end of the mechanical arm and maintain a preset vertical distance (for example, 1-2 meters) from the photovoltaic bracket, so as to collect the sensing data of the photovoltaic bracket from a bird's-eye view. The sensing device 220 can also be installed on the photovoltaic bracket, for example, the sensing device 220 is installed at a designated position of the photovoltaic bracket to collect the sensing data of the photovoltaic bracket under a fixed field of view. The embodiment of the present application does not limit the number and type of the sensing device 220. The positioning system 200 may comprise one or more sensing devices 220, and the sensing device 220 may comprise, for example, a depth camera or a laser radar. The above positioning apparatus 230 is coupled to the sensing device 220 to determine the position information of the photovoltaic robot 210 during the installation of the photovoltaic panel. The positioning apparatus 230 can also obtain the three-dimensional point cloud data of the photovoltaic bracket through the sensing device 220, for example, directly obtain the three-dimensional point cloud data collected by the sensing device 220, or obtain the three-dimensional point cloud data after the depth image data is converted. The positioning apparatus 230 determines the position information of the photovoltaic robot 210 based on the obtained three-dimensional point cloud data. In the embodiment of the present application, the photovoltaic bracket may be a tracking-type photovoltaic bracket, such as a horizontal single-axis tracking bracket or an inclined single-axis tracking bracket. It may also be a fixed-type photovoltaic bracket, such as a tilt-adjustable fixed bracket or a maximum-tilt-angle fixed bracket. The embodiment of the present application does not limit the type of photovoltaic bracket.

The positioning method of the photovoltaic robot is described below with reference to the figures.

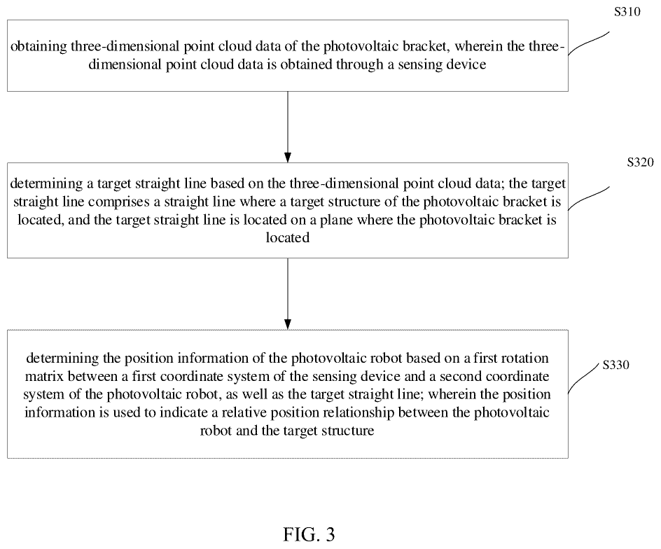

Please refer to FIG. 3, which shows a flow chart of a positioning method for a photovoltaic robot provided in some embodiments of the present application. The method is performed by the above positioning apparatus. The positioning apparatus can be installed on the photovoltaic robot; or it can be set independently of the photovoltaic robot, such as being located in a server or terminal device. The positioning method is used to determine the position information of the photovoltaic robot during the installation of photovoltaic panels. As shown in FIG. 3, the positioning method comprises at least the following steps:
S310: obtaining three-dimensional point cloud data of the photovoltaic bracket, wherein the three-dimensional point cloud data is obtained through a sensing device;
S320: determining a target straight line based on the three-dimensional point cloud data; the target straight line comprises a straight line where a target structure of the photovoltaic bracket is located, and the target straight line is located on a plane where the photovoltaic bracket is located;
S330: determining the position information of the photovoltaic robot based on a first rotation matrix between a first coordinate system of the sensing device and a second coordinate system of the photovoltaic robot, as well as the target straight line; wherein the position information is used to indicate a relative position relationship between the photovoltaic robot and the target structure.

The above positioning method obtains the three-dimensional point cloud data of the photovoltaic bracket based on the sensing device, and uses the three-dimensional point cloud data to determine the target straight line. The target straight line is the straight line where the target structure of the photovoltaic bracket is located. The target structure is used to locate the installation position of the photovoltaic panel on the photovoltaic bracket. For example, the rotation axis, beam, etc. of the photovoltaic bracket can be used as the target structure. The embodiment of the present application does not limit the selection of the target structure.

Therefore, the relative position relationship between the photovoltaic robot and the target structure is determined based on the three-dimensional point cloud data of the photovoltaic bracket, and the photovoltaic robot can be accurately positioned during the process of installing photovoltaic panels by the photovoltaic robot, so as to detect abnormal pose of the photovoltaic robot in time. In addition, the above positioning method determines the target straight line based on the three-dimensional point cloud data, where the target straight line is a planar straight line. In this way, the three-dimensional point cloud data is converted into a two-dimensional planar straight line. Through dimensionality reduction processing, the data processing process can be optimized to improve the positioning efficiency.

The position information of the photovoltaic robot comprises the position information of one or more reference points on the photovoltaic robot. The reference point is, for example, any point on the photovoltaic robot. For example, the reference point may include the centroid or center of the photovoltaic robot. For example, the photovoltaic robot comprises a mechanical arm, which is used to grab and place the photovoltaic panel. In this case, the reference point is, for example, any point on the mechanical arm, such as the centroid or center of the mechanical arm, to further improve the positioning accuracy.

In one implementation, the above position information comprises a first angle between the photovoltaic robot and the target structure. For example, the angle between a straight line where one or more reference points on the photovoltaic robot are located and the target straight line. Furthermore, said determining the position information of the photovoltaic robot based on the first rotation matrix and the target straight line comprises at least the following steps:
S331: determining a second angle between the target straight line and a first direction;
S332: determining a second rotation matrix between the first coordinate system and a third coordinate system based on the second angle; wherein the third coordinate system comprises a coordinate system of the target structure;
S333: determining a third rotation matrix between the second coordinate system and the third coordinate system based on the first rotation matrix and the second rotation matrix;
S334: determining the first angle based on the third rotation matrix.

In the embodiment of the present application, the target straight line is located in the plane where the photovoltaic bracket is located, that is, the target straight line is a planar straight line. After determining the target straight line, its straight-line equation y=ax+b can be obtained. The slope a of the target straight line represents the angle θ (that is, the first angle) between it and the first direction. The first direction is, for example, the positive or negative direction of any coordinate axis of the photovoltaic array coordinate system. In one implementation, as shown in FIG. 1, the photovoltaic array plane coordinate system is defined as the width direction of the photovoltaic panel array as the X-axis direction, the extended direction of the photovoltaic array as the Y-axis direction, and the positive direction of the Z-axis is defined as perpendicular to the surface of the photovoltaic panel and pointing upward. For example, the first direction can be the positive direction of the X-axis in FIG. 1.

The angle θ can be calculated by the inverse tangent function:

$$θ = arctan ( a ) ;$$

The angle value is converted into a rotation matrix, that is, the second rotation matrix R from the first coordinate system of the sensing device to the third coordinate system. The rotation matrix can be represented by the Euler angle of the rotation transformation. For the matrix rotating around the a-axis (perpendicular to the ground), it can be obtained by the following formula:

$$R = [ \begin{matrix}cos ( θ ) & - sin ( θ ) & 0 \\ sin ( θ ) & cos ( θ ) & 0 \\ 0 & 0 & 1\end{matrix} ] ;$$

Since the first rotation matrix R′ from the second coordinate system of the photovoltaic robot to the first coordinate system of the sensing device can be obtained by pre-calibration (that is, R′ is known), the third rotation matrix R^{T} between the second coordinate system and the third coordinate system can be determined by multiplying the above two rotation matrices:

$${R}^{T} = R \cdot {R}^{′} ;$$

The above position information can be determined by the rotation matrix R^{T} to indicate the relative position relationship between the photovoltaic robot and the target structure, for example, to determine the above first angle. In one implementation, the first angle can be determined by: determining the eigenvalue λ of the rotation matrix R^{T}; using the eigenvalue λ as an independent variable, and determining the first angle by an inverse cosine function.

In one implementation, the above position information comprises the distance between the photovoltaic robot and the target structure. For example, the distance between a first reference point on the photovoltaic robot and a second reference point on the target structure. The first reference point is, for example, any point on the photovoltaic robot, and the second reference point is, for example, any point on the target structure. Based on the coordinates of the first reference point in the first coordinate system, the rotation matrix R^{T}, and the line equation of the target straight line where the target structure is located, the distance between the first reference point and the second reference point can be determined.

Furthermore, in one implementation, if the above position information is outside the preset error range, the position information can be corrected. For example, if the first angle exceeds the error range, the pose of the photovoltaic robot can be controlled to adjust the angle. The preset error range is, for example, the error range of the initial pose of the photovoltaic robot. By correcting the pose of the photovoltaic robot, the error caused by the abnormal pose of the photovoltaic robot during the installation of photovoltaic panels can be further reduced. The process of determining the target straight line based on the three-dimensional point cloud data of the photovoltaic bracket in the above step S320 is described below.

A point cloud is a collection of multiple spatial points. A point cloud comprises multiple discrete points, each of which can correspond to a spatial position, which can be represented by three-dimensional position coordinates (x, y, z). For example, in the coordinate system of a sensing device, the front of the sensing device is the positive direction of the X-axis, the left side of the sensing device is the positive direction of the Y-axis, and the Z-axis is perpendicular to the ground. For another example, in the coordinate system of a photovoltaic robot, the front of the photovoltaic robot is the positive direction of the X-axis, the left side of the photovoltaic robot is the positive direction of the Y-axis, and the Z-axis is perpendicular to the ground. The above descriptions of three-dimensional position coordinates are for examples only. The embodiments of the present application do not limit the type of coordinate system or the selection of coordinate axes, as long as the spatial position of a point in the point cloud can be indicated.

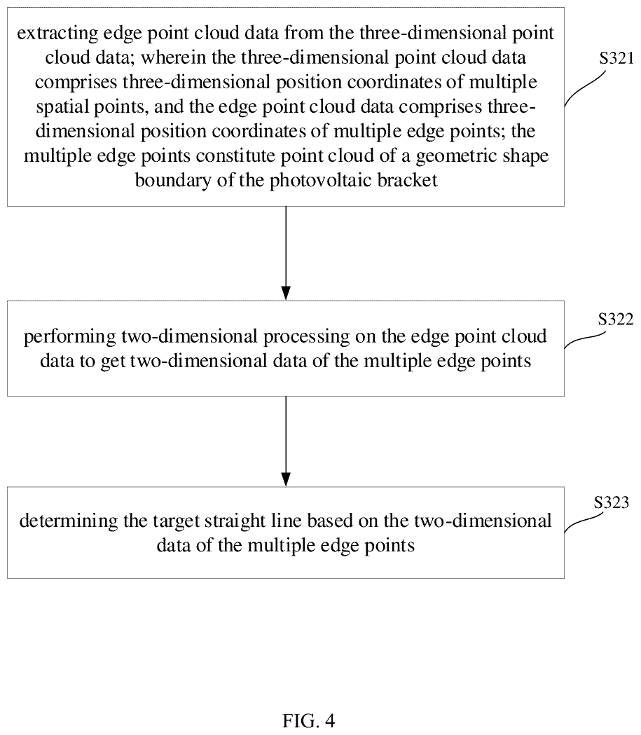

Please refer to FIG. 4, which is a flow chart of determining a target straight line based on three-dimensional point cloud data of a photovoltaic bracket provided in an embodiment of the present application. As shown in FIG. 4, the above step S320 may comprise:
S321: extracting edge point cloud data from the three-dimensional point cloud data; wherein the three-dimensional point cloud data comprises three-dimensional position coordinates of multiple spatial points, and the edge point cloud data comprises three-dimensional position coordinates of multiple edge points; the multiple edge points constitute point cloud of a geometric shape boundary of the photovoltaic bracket;
S322: performing two-dimensional processing on the edge point cloud data to get two-dimensional data of the multiple edge points;
S323: determining the target straight line based on the two-dimensional data of the multiple edge points.

The data of a spatial point in the point cloud may include the three-dimensional position coordinates of the point, and the three-dimensional position coordinates of multiple spatial points constitute the three-dimensional point cloud data. The three-dimensional point cloud data of the photovoltaic bracket is the three-dimensional point cloud data collected by the sensing device under a sensing field of view. The sensing field of view comprises the photovoltaic bracket and the environment in which the photovoltaic bracket is located. The three-dimensional point cloud data of the photovoltaic bracket (also called the original point cloud data) comprises not only the point cloud data of the photovoltaic bracket, but also the point cloud data of the environment. Therefore, the point cloud of the geometric shape boundary of the photovoltaic bracket can be extracted from the point cloud of the photovoltaic bracket by the edge detection method, so as to obtain the edge point cloud data. The edge point cloud data comprises the three-dimensional position coordinates of multiple edge points, and these edge points constitute the point cloud of the geometric shape boundary of the photovoltaic bracket. Further, the edge point cloud data is converted into the two-dimensional data of multiple edge points by two-dimensional processing. The target straight line can be identified based on the two-dimensional data of these edge points. The two-dimensional processing, for example, sets the Z-axis coordinate value of the edge point to 1, or maps the three-dimensional position coordinates of the edge point to a two-dimensional plane by projection to obtain the two-dimensional position coordinates of the edge point, etc. In one implementation, the original point cloud data may be first converted into a two-dimensional plane image, and edge detection may be performed on the two-dimensional plane image to determine the target straight line.

In some implementations of the edge detection process (S321), edge points may be extracted using curvature information of the point cloud. For example, the curvature information of the first point may be determined based on the three-dimensional position coordinates of the second point cloud region.

The original point cloud data comprises the three-dimensional position coordinates of multiple spatial points (original point clouds). Multiple spatial points constitute the first point cloud region. Among them, the multiple spatial points comprise a point P (first point), that is, the first point belongs to the first point cloud region. The first point also belongs to the second point cloud region, the second point cloud region is less than or equal to the first point cloud region, and the spatial points in the second point cloud region meet the preset adjacent condition (for the convenience of distinction, it is called the second adjacent condition). The second adjacent condition is, for example, the distance between any spatial point in the second point cloud region and the first point is less than or equal to the preset distance (for the convenience of distinction, it is called the second preset distance). That is, the point \vec{P} and the points in its neighborhood \vec{P}ᵢ constitute the second point cloud region.

In one implementation, the curvature information may comprise the curvature value of the point \vec{P}. The curvature value may be determined by surface fitting. For example, based on the point \vec{P} and the points in its neighborhood \vec{P}ᵢ, a surface fitting is performed by the least squares method to obtain a first surface; based on the feature information of the first surface, the curvature value K of the point \vec{P} (the first point) is determined:

$$κ = \frac{{λ}_{0}}{{λ}_{0} + {λ}_{1} + {λ}_{2}} ;$$

wherein the feature information comprises the eigenvalues (λ₀ [symbol] λ₁ [symbol] λ₂) of the covariance matrix of the first surface.

In one implementation, the curvature information may comprise the angle value of the angle between the normal line of the point \vec{P} and the normal line of the point \vec{P}ᵢ. The angle value may also be determined by surface fitting. Taking point \vec{P} and point \vec{P}₁ (second point) as an example, point \vec{P}₁ belongs to the second point cloud region. With point \vec{P} and point \vec{P}₁ as the center points, surface fitting is performed to obtain the first surface and the second surface. In this case, the feature information may comprise normal vectors. The normal vector of the first point can be obtained through the first surface, and the normal vector of the second point can be obtained through the second surface, so that the angle value of the angle between the two normal vectors can be determined, which is the angle between the normal line of the first point and the normal line of the second point.

When the above curvature information meets the preset curvature condition, the first point is taken as the edge point. The preset curvature condition may comprise any one of the following: when the curvature value of the point \vec{P} is greater than or equal to the curvature threshold; when the angle value between the normal line of the point \vec{P} and the normal line of the point \vec{P}ᵢ is greater than or equal to the angle threshold; or when the curvature value of the point \vec{P}ᵢ is greater than the curvature threshold, and the angle value between the normal line of the point \vec{P} and the normal line of the point \vec{P}ᵢ is greater than the angle threshold.

For each spatial point in the original point cloud, the above edge detection process can be used to determine whether it is an edge point, so that the edge point cloud is extracted from the original point cloud. The edge point cloud comprises multiple edge points, and the edge point cloud data comprises the three-dimensional position coordinates of multiple edge points. Further, the edge point cloud data is converted into two-dimensional data of multiple edge points through two-dimensional processing. Based on the two-dimensional data of multiple edge points, the target straight line can be determined. The process of determining the target straight line is described below.

The multiple edge points comprise a first edge point Q1 (x1, y1, z1) and a second edge point Q2 (x2, y2, z2). Q1 and Q2 are any two edge points in the edge point cloud. The values of z1 and z2 in the three-dimensional position coordinates of Q1 and Q2 are set to 1 to obtain the two-dimensional data of Q1 and Q2, i.e., Q1 (x1, y1, 1) and Q2 (x2, y2, 1). A straight line L1 can be determined by line fitting based on these two coordinates, and the straight line L1 can be regarded as a first planar straight line. Similarly, the two-dimensional data of other edge points in the multiple edge points can also be obtained in the above manner. Based on the two-dimensional data of the multiple edge points, the inner points of the straight line L1 can be screened out from the multiple edge points. In one implementation, based on the two-dimensional data of the multiple edge points, the inner points of the straight line L1 can be determined from the multiple edge points: based on the two-dimensional data of the multiple edge points, the first distance between the multiple edge points and the straight line L1 is determined; when the first distance is less than or equal to the first preset distance, the edge points corresponding to the first distance are determined from the multiple edge points as the inner points of the first planar straight line. That is, the inner point of the straight line L1 is determined by the distance between each edge point and the straight line L1. That is, among the multiple edge points, the edge point whose distance d from the straight line L1 is less than or equal to the first preset distance is the inner point of the straight line L1.

When the number of inner points of the line L1 is greater than or equal to the first preset number, the line L1 is determined to be the first candidate line. In one implementation, the number of iterations N can be set, multiple edge points can be traversed, Q1 and Q2 can be selected multiple times, and the above process can be repeated to determine the first candidate line. When there are multiple first candidate lines, the candidate line with the largest number of inner points among the multiple first candidate lines is determined as the initial target candidate line. In the initial implementation, the initial target candidate line can be used as the target straight line.

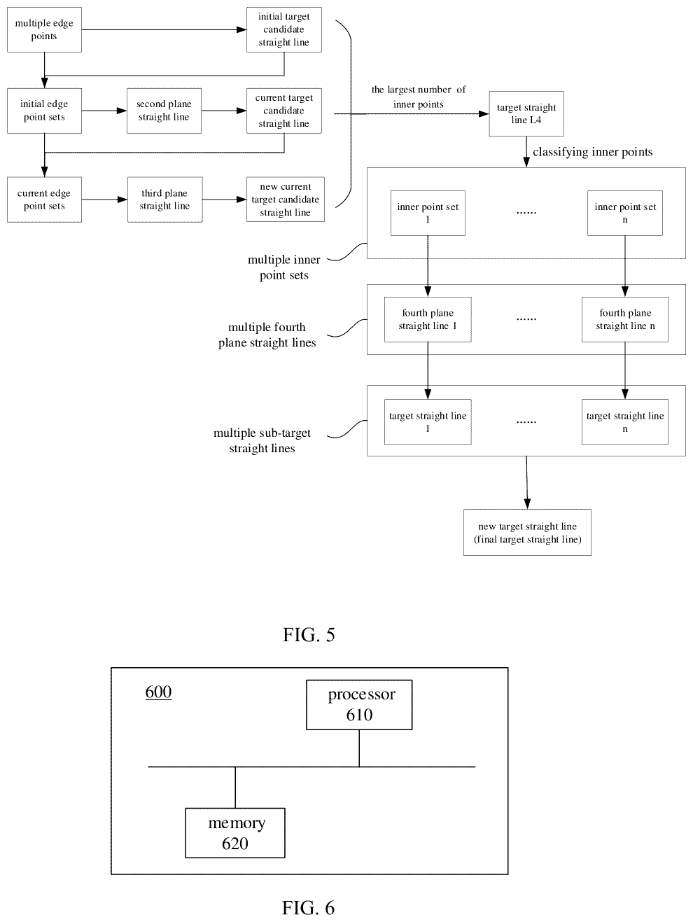

Alternatively, a loop iteration is performed based on the initial target candidate straight line to determine the final target straight line. The accuracy of target straight line detection is improved by loop iteration. Please refer to FIG. 5, which is a schematic diagram of a target straight line determination process provided in an embodiment of the present application. As shown in FIG. 5, after removing the inner points of the initial target candidate straight line from multiple edge points, the remaining edge points form an initial edge point set. A third edge point Q3 (x3, y3, z3) and a fourth edge point Q4 (x4, y4, z4) are selected from the initial edge point set. Q3 and Q4 are any two edge points of the initial edge point set. A straight line L2 can be determined by performing straight line fitting based on the two-dimensional data of Q3 and Q4, and the straight line L2 can be regarded as a second planar straight line. When the number of inner points of the straight line L2 is greater than or equal to the second preset number, the straight line L2 is determined as the current target candidate straight line.

Repeat the following iterative process until the number of target candidate lines is greater than or equal to a third preset number:

The remaining edge points after the initial edge point set removes the inner points of the current target candidate line constitute the current edge point set. For example, the current edge point set comprises the remaining edge points after the inner points of line L2 are removed from the initial edge point set. The fifth edge point Q5 (x5, y5, 25) and the sixth edge point Q6 (x6, y6, 26) are selected from the current edge point set. Q5 and Q6 are any two edge points of the current edge point set. A straight line L3 can be determined by performing straight line fitting based on the two-dimensional data of Q5 and Q6, and the straight line L3 can be regarded as a third planar straight line. When the number of inner points of straight line L3 is greater than or equal to the fourth preset number, a new current target candidate line is determined based on straight line L3. Repeat the above cycle until the number of target candidate lines is greater than or equal to the third preset number, and determine the target candidate line with the largest number of inner points as target straight line L4. The above first preset number, second preset number, and third preset number can be the same or different.

In one implementation, in order to further improve the accuracy and prevent the interrupted straight line from being identified as a straight line, the target straight line L4 can be verified. The target straight line LA comprises multiple inner points, wherein the inner points that meet the first adjacent condition belong to the same point set. The first adjacent condition is, for example, that the distance between any two inner points is less than or equal to a third preset distance. The above first preset distance, the second preset distance, or the third preset distance can be the same or different.

In this way, these inner points can be classified based on the distance between the inner points of the target straight line LA to obtain at least one inner point set, each of which comprises at least two inner points. Take the inner points of the target straight line L4 as an example, including A1, A2, and A3. Assume that A1, A2, and A3 correspond to labels a1, a2, and a3, respectively, and each label corresponds to an independent category. Traverse A1, A2, and A3, and for each inner point, calculate the distance between it and other inner points. If the distance is less than or equal to the third preset distance, it is considered that the two points meet the first adjacent condition. Assume that among A1, A2, and A3, A1 and A2 are adjacent. Then A1 and A2 are merged into the same category, and A1 and A2 constitute an inner point set. Similarly, when the target straight line L4 has more inner points, repeat the above classification process until all the inner points of the target straight line L4 are classified into appropriate categories. Based on the above classification, interval detection is performed on the point cloud region where the previously fitted target line L4 is located. If the number of the inner point sets after classification is one, the point cloud region where the target straight line L4 is located can be regarded as having no gap, and the detected target straight line L4 meets the accuracy requirement. If the number of the inner point sets after classification is multiple, the point cloud region where the target straight line L4 is located can be regarded as having a gap. The point cloud region can be divided into multiple sub-point cloud regions, and line detection is performed in different sub-point cloud regions to obtain multiple sub-target straight lines. A line that meets the preset conditions is selected from the multiple sub-target straight lines as the final target straight line. As shown in FIG. 5, a line fitting is performed based on the multiple inner point sets 1-n (n is an integer greater than or equal to 2) obtained after classification to determine multiple fourth planar straight lines 1-n. The multiple inner point sets correspond to the multiple fourth planar straight lines one by one: when there are multiple fourth planar straight lines, multiple straight lines L1 are determined based on the multiple fourth planar straight lines. The target straight line detection is re-performed based on the multiple straight lines L1, and the multiple target straight lines 1-n are re-determined (that is, the multiple sub-target straight lines are re-determined); the process can refer to the determination process of the above-mentioned target straight line L4. A new target straight line is selected from the re-determined multiple target straight lines 1-n. The new target straight line comprises the straight line with the longest length and/or the largest number of inner points among the re-determined multiple target straight lines. For example, after classification, three inner point sets are obtained, and each of the three inner point sets can be fitted to determine a straight line L1, thereby obtaining three straight lines L1. Based on the three straight lines L1, three target straight lines can be determined. By comparing the three target straight lines, the target straight line with the largest number of inner points or the longest length is selected as the new target straight line L4.

In one implementation, the three-dimensional point cloud data in any of the above embodiments may be filtered to filter out unnecessary point cloud data and reduce the point cloud density, thereby improving the recognition efficiency and accuracy of the target straight line. The filtering process, for example, comprises one or more of pass-through filtering, voxel grid filtering, and outlier removal filtering. The above filtering processes are described below.

(1) Pass-through filtering: Assume that the three-dimensional position coordinates of each spatial point in the point cloud are expressed as (x, y, z), and the ranges of these three coordinate values can be set separately. For example, the range of x is (−1, 2), the range of y is (−3,3), and the range of z is (0.1, 2), and the unit is meter. Traverse the x, y, and z values of each point in the point cloud and remove the point clouds outside the range. The above x, y, and z ranges include the coordinate value range of the photovoltaic bracket in the first coordinate system when the photovoltaic robot is working.

(2) Voxel grid filtering: In one implementation, the point cloud obtained by depth image conversion is relatively dense, resulting in a high computation load. Therefore, the point cloud can be down sampled by voxel grid filtering to reduce the amount of computation. For example, the length, width, and height of the voxel are set to the same value (for example, 0.005 m), and for each point P (x, y, z) in the point cloud can be assigned to a voxel in a three-dimensional grid. The calculation process is as follows:

$$i = ⌊ \frac{x}{l} ⌋ , j = ⌊ \frac{y}{w} ⌋ , k = ⌊ \frac{z}{h} ⌋ ;$$

wherein i, j, k represent the index of the point in the three-dimensional grid, and the symbol └ ┘ represents rounding down. For all points (P1, P2 . . . , Pn) in each voxel, the centroid C(Vᵢⱼₖ) is calculated as the representative point. The process is as follows:

$$C ( {V}_{ijk} ) = ( \frac{1}{n} {\sum }_{m = 1}^{n} {x}_{m} , \frac{1}{n} {\sum }_{m = 1}^{n} {y}_{m} , \frac{1}{n} {\sum }_{m = 1}^{n} {z}_{m} ) ;$$

wherein Vᵢⱼₖ represents the voxel with index (i, j, k), n is the number of points in the voxel, and (xₘ, yₘ, zₘ) is the coordinate of the m-th point in the voxel Vᵢⱼₖ. The above operation is performed on all voxels, and the final point set C(V₀₀₀), C (V₀₀₁), . . . , C(Vᵢⱼₖ) constitutes the point cloud after voxel grid filtering.

(3) Outlier removal filtering: It is used to remove points that appear abnormal compared to surrounding points. For each point Pᵢ in the point cloud, calculate its average distance μᵢ and standard deviation σᵢ from all other points:

$${μ}_{i} = \frac{1}{k} {\sum }_{j = 1}^{k} \backslash {lVertP}_{i} - {P}_{j} \backslash rVert ;$$

$${σ}_{i} = \sqrt{\frac{1}{k} {\sum }_{j = 1}^{k} {( \backslash {lVertP}_{i} - {P}_{j} \backslash rVert - {μ}_{i} )}^{2}} ;$$

wherein k is the number of neighbors of Pᵢ, \lVert⋅\rVert refers to the Euclidean distance. By setting the threshold c, a range value [μᵢ−c·σᵢ,μᵢ+c·σᵢ]. Oil can be calculated. If it exceeds the range, the point is removed from the point cloud as an outlier.

Based on the same technical concept, an embodiment of the present application also provides a positioning apparatus for a photovoltaic robot. FIG. 6 shows a schematic diagram of the structure of a positioning apparatus for a photovoltaic robot provided in an embodiment of the present application. As shown in FIG. 6, the positioning apparatus 600 comprises a processor 610 for calling instructions stored in a memory 620, and when the instructions are called by the processor 610, the processor 610 executes any one of the positioning methods in the above embodiments.

It should be noted that the above embodiments can be freely combined as needed. The above are only preferred implementations of the present application. It should be pointed out that for ordinary technicians in this technical field, several improvements and modifications can be made without departing from the principles of the present application, and these improvements and modifications should also be regarded as the protection scope of the present application.

1. A positioning method for a photovoltaic robot, characterized in that the photovoltaic robot is used to install a photovoltaic panel on a photovoltaic bracket, and the positioning method is used to determine position information of the photovoltaic robot during an installation process of the photovoltaic panel, and the positioning method comprises:
obtaining three-dimensional point cloud data of the photovoltaic bracket, wherein the three-dimensional point cloud data is obtained through a sensing device;
determining a target straight line based on the three-dimensional point cloud data, wherein the target straight line comprises a straight line where a target structure of the photovoltaic bracket is located, the target straight line is located in a plane where the photovoltaic bracket is located and the target structure is used to locate the installation position of the photovoltaic panel on the photovoltaic bracket;
determining the position information based on a first rotation matrix between a first coordinate system of the sensing device and a second coordinate system of the photovoltaic robot, as well as the target straight line; wherein the position information is used to indicate a relative position relationship between the photovoltaic robot and the target structure;
said determining a target straight line based on the three-dimensional point cloud data comprises:
extracting edge point cloud data from the three-dimensional point cloud data; wherein the three-dimensional point cloud data comprises three-dimensional position coordinates of multiple spatial points, and the edge point cloud data comprises three-dimensional position coordinates of multiple edge points; the multiple edge points constitute point cloud of a geometric shape boundary of the photovoltaic bracket;
performing two-dimensional processing on the edge point cloud data to get two-dimensional data of the multiple edge points;
determining the target straight line based on the two-dimensional data of the multiple edge points;
said determining the target straight line based on the two-dimensional data of the multiple edge points comprises:
selecting a first edge point and a second edge point from the multiple edge points; determining a first planar straight line based on two-dimensional data of the first edge point and the second edge point; determining the first planar straight line as a first candidate straight line when a number of inner points of the first planar straight line is greater than or equal to a first preset number;
traversing the multiple edge points, when there are multiple first candidate straight lines, determining a candidate straight line with a largest number of inner points among the multiple first candidate straight lines as an initial target candidate straight line;
selecting a third edge point and a fourth edge point from an initial edge point set; determining a second planar straight line based on two-dimensional data of the third edge point and the fourth edge point; determining the second planar straight line as a current target candidate straight line when a number of inner points of the second planar straight line is greater than or equal to a second preset number; wherein the initial edge point set comprises the remaining edge points after removing the inner points of the initial target candidate straight line from the multiple edge points;
repeating the following iterative process until a number of the target candidate straight lines is greater than or equal to a third preset number;
selecting a fifth edge point and a sixth edge point from a current edge point set; determining a third planar straight line based on two-dimensional data of the fifth edge point and the sixth edge point; determining a new current target candidate straight line based on the third planar straight line when the number of inner points of the third planar straight line is greater than or equal to a fourth preset number; wherein the current edge point set comprises the remaining edge points after removing the inner points of the current target candidate straight line from the initial edge point set;
determining the target candidate straight line with a largest number of inner points as the target straight line when a number of target candidate lines is greater than or equal to the third preset number.

2.-3. (canceled)

4. The positioning method according to claim 1, characterized in that multiple inner points of the target straight line are divided into multiple inner point sets, and the inner points that meet a first adjacent condition among the multiple inner points of the target straight line belong to the same inner point set, and the positioning method further comprises:
determining multiple fourth planar straight lines by performing straight line fitting based on the multiple inner point sets;
determining multiple first planar straight lines based on the multiple fourth planar straight lines, and re-determining multiple target straight lines;
selecting a new target straight line from the re-determined multiple target straight lines, wherein the new target straight line comprises the straight line with the longest length and/or the largest number of inner points among the re-determined multiple target straight lines.

5. The positioning method according to claim 1, further comprises:
determining a first distance between multiple edge points and the first planar straight line based on two-dimensional data of the multiple edge points;
determining an edge point corresponding to the first distance from the multiple edge points as an inner point of the first planar straight line when the first distance is less than or equal to a first preset distance.

6. The positioning method according to claim 1, characterized in that the multiple spatial points constitute a first point cloud region; the multiple spatial points comprise a first point, the first point also belongs to a second point cloud region, the second point cloud region is less than or equal to the first point cloud region; and the spatial points in the second point cloud region meet a second adjacent condition; the second point cloud region further comprises a second point;
said extracting edge point cloud data of a photovoltaic bracket from three-dimensional point cloud data comprises:
determining curvature information of the first point based on three-dimensional position coordinates of the second point cloud region; wherein the curvature information comprises a curvature value of the first point and/or an angle value between the normal of the first point and the normal of the second point;
taking the first point as the edge point when the curvature information meets a preset curvature condition.

7. The positioning method according to claim 6, characterized in that said determining curvature information of the first point based on three-dimensional position coordinates of the second point cloud region comprises:
performing surface fitting with the first point and the second point as center points, respectively, based on the three-dimensional position coordinates of the second point cloud region, to obtain a first surface and a second surface;
determining the curvature value of the first point and the angle value between the normal of the first point and the normal of the second point based on the feature information of the first surface and the second surface.

8. The positioning method according to claim 1, characterized by further comprising:
performing filtering on the three-dimensional point cloud data;
wherein the filtering comprises one or more of pass-through filtering, voxel grid filtering, and outlier removal filtering.

9. The positioning method according to claim 1, characterized in that the position information comprises a first angle between the photovoltaic robot and the target structure;
said determining the position information based on the first rotation matrix between the first coordinate system of the sensing device and the second coordinate system of the photovoltaic robot, as well as the target straight line comprises:
determining a second angle between the target straight line and a first direction, wherein the first direction comprises the positive or negative direction of any coordinate axis of the photovoltaic array coordinate system;
determining a second rotation matrix between the first coordinate system and a third coordinate system based on the second angle; wherein the third coordinate system comprises a coordinate system of the target structure;
determining a third rotation matrix between the second coordinate system and the third coordinate system based on the first rotation matrix and the second rotation matrix;
determining the first angle based on the third rotation matrix.

10. A positioning apparatus for a photovoltaic robot, characterized by comprising a processor for calling instructions stored in a memory, wherein when the instructions are called by the processor, the processor executes the positioning method according to claim 1.

11. A positioning system for a photovoltaic robot, characterized by comprising:
a sensing device, which is installed on the photovoltaic robot and is used to collect sensing data of the photovoltaic bracket, wherein the sensing data comprises three-dimensional point cloud data, or the sensing data is used to determine the three-dimensional point cloud data;
a positioning apparatus as claimed in claim 10, which is coupled to the sensing device.
